(19) United States
(12) Patent Application Publication
(10) Pub. No.: US 2018/0274644 A1
(43) Pub. Date: Sep. 27, 2018

(54) AUTOMATIC TRANSMISSION

(71) Applicant: AISIN AW CO., LTD., Anho-shi, Aichi-ken (JP)

(72) Inventors: Nobutada SUGIURA, Nishio (JP); Masayuki UCHIDA, Nukata (JP)

(73) Assignee: AISIN AW CO., LTD., Anjo-shi, Aichi-ken (JP)

(21) Appl. No.: 15/537,607

(22) PCT Filed: Jan. 12, 2016
(86) PCT No.: PCT/JP2016/050739

§ 371 Date: Jun. 19, 2017

(30) Foreign Application Priority Data
Feb. 12, 2015 (JP) 2015-025568

(51) Int. Cl. F16H 37/08; F16H 9/18; F16H 37/02; F16H 3/54; F16H 3/66

(52) U.S. Cl. CPC F16H 37/0846; F16H 9/18; F16H 37/022; F16H 3/54; F16H 3/66; F16H 2200/2038; F16H 2200/0034; F16H 2200/2005; F16H 2200/2007; F16H 2200/2035; F16H 2037/023

(57) ABSTRACT

An automatic transmission includes: an input shaft disposed on a first axis and drivably coupled to a drive source; a transfer mechanism provided between the first axis and a second axis and that transfers rotation around the first axis to the second axis; a continuously variable speed change mechanism that is capable of continuously changing a speed ratio and has a primary pulley disposed on the second axis, a secondary pulley disposed on a third axis, a belt wound around the two pulleys; and an output shaft disposed on a fourth axis and that outputs rotation at a changed speed. The centers of the second axis and third axis are disposed on one side and the other side, respectively, of a first line that connects between the centers of the first axis and fourth axis and serves as a boundary as viewed in an axial direction.

This application is a National Stage of International Application No. PCT/JP2016/050739, filed on Jan. 12, 2016, which claims priority from Japanese Patent Application No. 2015-025568, filed on Feb. 12, 2015, the contents of all of which are incorporated herein by reference in their entirety.

### TECHNICAL FIELD

The present disclosure relates to an automatic transmission mounted on a vehicle, for example, and particularly to an automatic transmission that has a continuously variable speed change mechanism.

### BACKGROUND ART

Automatic transmissions that use a continuously variable speed change mechanism, such as a belt-type continuously variable speed change mechanism that includes a pair of pulleys and a metal belt wound around the pulleys and that continuously varies a speed by changing the effective diameters of the pulleys, have been widespread as automatic transmissions that are suitable for use in vehicles, for example.

Automatic transmissions that include axes that are parallel to each other, namely first to fourth axes, have been widespread as this type of automatic transmissions. Among such automatic transmissions, there is known an automatic transmission in which a crankshaft of an internal combustion engine and a primary pulley of a continuously variable speed change mechanism are disposed on the first axis, a secondary pulley of the continuously variable speed change mechanism is disposed on the second axis, a speed reduction gear train is disposed on the third axis, and a differential device and a drive shaft are disposed on the fourth axis, for example (see Patent Document 1).

In this automatic transmission, rotary elements with a large diameter are provided on the first axis, the second axis, and the fourth axis, and the first axis, the second axis, and the fourth axis are disposed so as to form a generally acute triangle as viewed in the axial direction from the viewpoint of the size of the automatic transmission and the mountability to a vehicle. In order to secure the minimum ground clearance, in addition, the fourth axis which is coaxial with the drive shaft is disposed in a lower portion of the automatic transmission, the first axis is disposed obliquely above the fourth axis, and the second axis is disposed obliquely above the first axis.

### RELATED-ART DOCUMENTS

### Patent Documents

[Patent Document 1] Japanese Patent Application Publication No. 2014-224562 (JP 2014-224562 A)

### SUMMARY OF THE DISCLOSURE

In the automatic transmission described in Patent Document 1, however, the crankshaft of the internal combustion engine and the primary pulley are disposed on the first axis, and thus the secondary pulley which is disposed on the second axis is disposed above the crankshaft by an amount corresponding to the difference in height between the primary pulley and the secondary pulley. Therefore, the automatic transmission significantly projects upward with respect to the crankshaft. Thus, the automatic transmission may interfere with another component when the automatic transmission is mounted onto a vehicle, which results in poor mountability.

It is therefore an object to provide an automatic transmission that provides improved mountability to a vehicle in spite of including a continuously variable speed change mechanism.

The present disclosure provides an automatic transmission including: an input member disposed on a first axis and drivably coupled to a drive source; a transfer mechanism that is provided between the first axis and a second axis that is parallel to the first axis and that transfers rotation around the first axis to the second axis; a continuously variable speed change mechanism that is capable of continuously changing a speed ratio and has a primary pulley disposed on the second axis, a secondary pulley disposed on a third axis that is parallel to the second axis, and a belt wound around the two pulleys; and an output member disposed on a fourth axis that is parallel to the third axis and meshed with a drive pinion gear on the third axis to output rotation at a changed speed, wherein a center of the second axis and a center of the third axis are disposed on one side and the other side, respectively, of a first line that connects between a center of the first axis and a center of the fourth axis and that serves as a boundary as viewed in an axial direction.

In the automatic transmission, the center of the second axis and the center of the third axis are disposed on one side and the other side, respectively, of the first line which connects between the center of the first axis and the center of the fourth axis and which serves as the boundary as viewed in the axial direction. Thus, the center of the second axis or the center of the third axis can be disposed below the center of the first axis. Therefore, the center of either the primary pulley or the secondary pulley can be disposed below a drive shaft of the drive source. Thus, the position of arrangement of the continuously variable speed change mechanism in the automatic transmission can be lowered compared to a case where the center of either the primary pulley or the secondary pulley is disposed coaxially with the drive shaft of the drive source. The center of any of the primary pulley and the secondary pulley may be disposed below the drive shaft of the drive source. Consequently, the upward projection of the automatic transmission can be reduced, which allows the automatic transmission to provide improved mountability to a vehicle in spite of including the continuously variable speed change mechanism. In addition, the rotational direction of the output member and the rotational direction around the second axis and the third axis are opposite to each other. Therefore, it is difficult that lubricating oil splashed by a pulley disposed on the second axis or the third axis disposed on the lower side is scattered in the direction of the output shaft. Consequently, the stirring resistance of the output member against the lubricating oil can be reduced, which can improve the fuel efficiency.

### BRIEF DESCRIPTION OF THE DRAWINGS

FIG. 1 is a skeleton diagram illustrating an automatic transmission according to a first embodiment.

FIG. 2A is a front view illustrating the positions of axes of the automatic transmission according to the first embodiment.

FIG. 2B is an engagement table for the automatic transmission according to the first embodiment.

FIG. 3A is a skeleton diagram of an automatic transmission according to a second embodiment.

FIG. 3B is an engagement table for the automatic transmission according to the second embodiment.

FIG. 4A is a skeleton diagram of an automatic transmission according to a third embodiment.

FIG. 4B is an engagement table for the automatic transmission according to the third embodiment.

FIG. 5A is a skeleton diagram of an automatic transmission according to a fourth embodiment.

FIG. 5B is an engagement table for the automatic transmission according to the fourth embodiment.

FIG. 6 is a front view illustrating the positions of axes of an automatic transmission according to another embodiment.

### DETAILED DESCRIPTION OF THE PREFERRED EMBODIMENTS

### First Embodiment

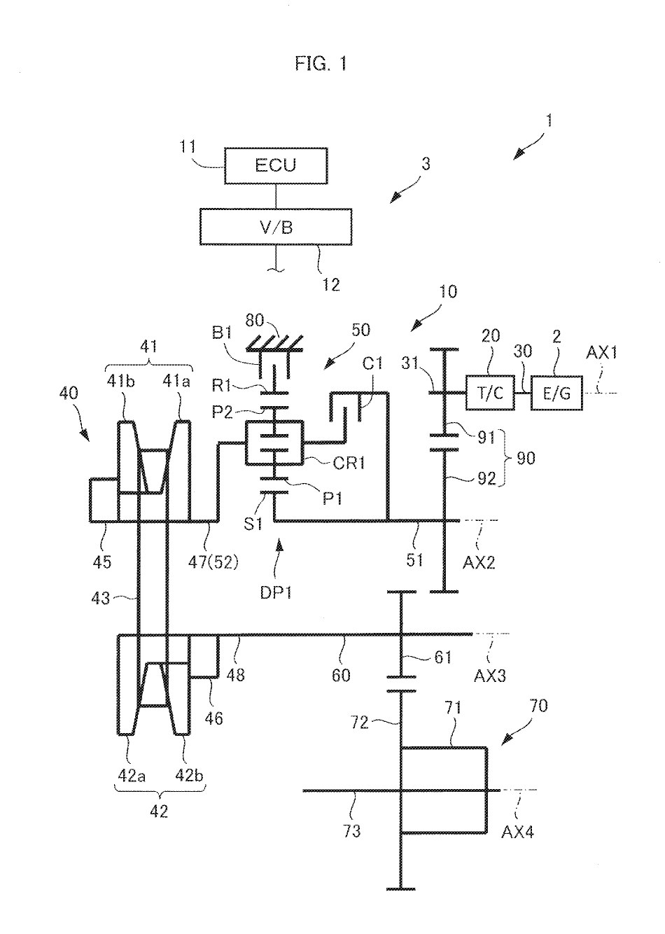

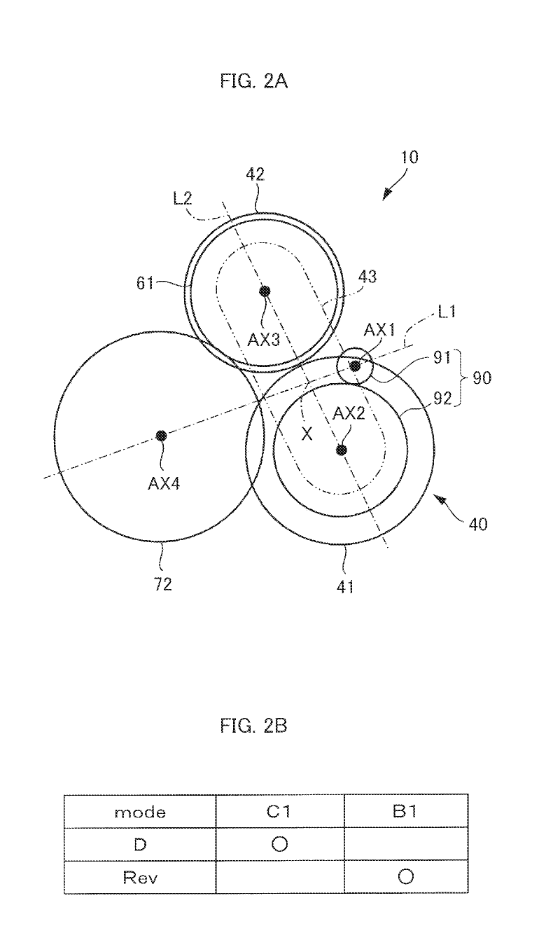

An automatic transmission 10 according to a first embodiment will be described below with reference to FIGS. 1, 2A, and 2B. The term “drivably coupled” as used herein refers to a state in which rotary elements are coupled to each other in such a way that allows transfer of a drive force, which includes a state in which the rotary elements are coupled to each other so as to rotate together with each other, and a state in which the rotary elements are coupled to each other via a clutch or the like in such a way that allows transfer of a drive force.

A schematic configuration of a vehicle 1 that includes the automatic transmission 10 according to the embodiment will be described with reference to FIG. 1. The vehicle 1 has an internal combustion engine 2 such as a gasoline engine and a diesel engine as a drive source, for example, and includes the internal combustion engine (drive source) 2, a vehicle drive device 3, and wheels (not illustrated). The vehicle drive device 3 includes the automatic transmission 10, a control device (ECU) 11, and a hydraulic control device 12.

The automatic transmission 10 includes a torque converter 20, input shafts (input members) 30 and 31, a transfer mechanism 90, a continuously variable speed change mechanism 40, a forward/reverse switching mechanism 50, a differential device 70, left and right drive shafts (output members) 73, and a transmission case 80 that houses such components. The automatic transmission 10 includes axes that are parallel to each other, namely a first axis AX1 to a fourth axis AX4. The transmission case 80 rotatably supports the input shafts 30 and 31 and the drive shafts 73, and houses the continuously variable speed change mechanism 40 and the forward/reverse switching mechanism 50.

The first axis AX1 is coaxial with a crankshaft of the internal combustion engine 2. The input shaft 30 which is drivably coupled to the crankshaft, the torque converter 20 which is coupled to the input shaft 30, the input shaft 31 which is coupled to the output side of the torque converter 20, and a drive gear 91 of the transfer mechanism 90 are disposed on the first axis AX1.

A driven gear 92 of the transfer mechanism 90, the forward/reverse switching mechanism 50, a primary pulley 41 and an input shaft 47 of the continuously variable speed change mechanism 40 are disposed on the second axis AX2. A secondary pulley 42 and an output shaft 48 of the continuously variable speed change mechanism 40, an intermediate shaft 60, and an output gear (drive pinion gear) 61 are disposed on the third axis AX3. The differential device 70 and the left and right drive shafts 73 are disposed on the fourth axis AX4. The left and right wheels (not illustrated) are provided on the drive shafts 73.

The input shaft 31 of the automatic transmission 10 is connected to the forward/reverse switching mechanism 50 via the transfer mechanism 90. The transfer mechanism 90 has the drive gear 91 and the driven gear 92 which are meshed with each other, and transfers rotation of the input shaft 31 to an input shaft 51 of the forward/reverse switching mechanism 50 with the direction of the rotation reversed. That is, the transfer mechanism 90 is provided between the first axis AX1 and the second axis AX2, and transfers rotation around the first axis AX1 to the second axis AX2.

The forward/reverse switching mechanism 50 includes the input shaft 51, a planetary gear DP1, a first clutch (first engagement element) C1, a first brake (second engagement element) B1, and an output shaft 52, and can output rotation of the input shaft 51 from the output shaft 52 with the output shaft 52 rotating forward and in reverse through engagement and disengagement of the first clutch C1 and the first brake B1.

The planetary gear DP1 is constituted of a double-pinion planetary gear that has a sun gear (first rotary element) 51 drivably coupled to the input shaft 51 and the first clutch C1, a carrier (second rotary element) CR1 drivably coupled to the output shaft 52 and the first clutch C1, and a ring gear (third rotary element) R1 that is drivably coupled to the first brake B1 and that can be made rotationally stationary. The carrier CR1 rotatably supports pinions P1 and P2 meshed with the sun gear S1 and the ring gear R1, respectively.

The planetary gear DP1 is brought into a forward mode in which the input shaft 51 and the output shaft 52 are directly coupled to each other to rotate in the same direction as each other by engaging the first clutch C1 and disengaging the first brake B1. Meanwhile, the planetary gear DP1 is brought into a reverse mode in which the input shaft 51 and the output shaft 52 are coupled to each other via the planetary gear DP1 to rotate in directions opposite to each other by disengaging the first clutch C1 and engaging the first brake B1 (see FIG. 2B).

The continuously variable speed change mechanism 40 is constituted of a belt-type continuously variable automatic speed change mechanism that is capable of continuously changing a speed ratio and has the primary pulley 41 and the input shaft 47 which are disposed on the second axis AX2, the secondary pulley 42 and the output shaft 48 which are disposed on the third axis AX3, and an endless belt 43 wound around the two pulleys 41 and 42. The input shaft 47 is drivably coupled to the output shaft 52. The output shaft 48 is drivably coupled to intermediate shaft 60.

The primary pulley 41 has a fixed sheave 41a and a movable sheave 41b that have respective wall surfaces formed in a conical shape so as to oppose each other. The fixed sheave 41a is fixed so as to be immovable in the axial direction with respect to the input shaft 47, and the movable sheave 41b is supported so as to be movable in the axial direction with respect to the input shaft 47. The belt 43 is held by a groove portion with a V-shape in section formed by the fixed sheave 41a and the movable sheave 41b.

Similarly, the secondary pulley 42 has a fixed sheave 42a and a movable sheave 42b that have respective wall surfaces formed in a conical shape so as to oppose each other, The fixed sheave 42a is fixed so as to be immovable in the axial direction with respect to the output shaft 48, and the movable sheave 42b is supported so as to be movable in the axial direction with respect to the output shaft 48. The belt 43 is held by a groove portion with a V-shape in section formed by the fixed sheave 42a and the movable sheave 42b. The fixed sheave 41a of the primary pulley 41 and the fixed sheave 42a of the secondary pulley 42 are disposed opposite to each other in the axial direction with respect to the belt 43.

In addition, a hydraulic servo 45 is disposed on the back surface side of the movable sheave 41b of the primary pulley 41, and a hydraulic servo 46 is disposed on the back surface side of the movable sheave 42b of the secondary pulley 42. A primary pressure is supplied to the hydraulic servo 45 as a working oil pressure from a primary pressure control valve (not illustrated) of the hydraulic control device 12. A secondary pressure is supplied to the hydraulic servo 46 as a working oil pressure from a secondary pressure control valve (not illustrated) of the hydraulic control device 12. The hydraulic servos 45 and 46 are configured to be supplied with the working oil pressures to generate a belt holding force corresponding to load torque, and to generate a holding force for changing or fixing the speed ratio.

The differential device 70 has a differential case 71 that internally houses a differential gear (not illustrated). The differential case 71 has a mount ring gear 72 with a relatively large diameter fixed thereto. The mount ring gear 72 is connected to the differential gear via the differential case 71. The left and right drive shafts 73 which are supported by the differential case 71 via the differential gear are connected to the mount ring gear 72. The output gear 61 on the third axis AX3 and the mount ring gear 72 are meshed with each other. Moreover, the output gear 61 has a relatively small diameter and the mount ring gear 72 has a relatively large diameter, so that a relatively large speed reduction ratio is obtained. That is, the drive shafts 73 are disposed on the fourth axis AX4 to output rotation at a changed speed.

Here, the positional relationship among the first axis AX1 to the fourth axis AX4 of the automatic transmission 10 according to the embodiment will be described. FIG. 2A is a schematic diagram illustrating the arrangement of the axes as the automatic transmission 10 is viewed in the axial direction, in which the center of the second axis AX2 and the center of the third axis AX3 are disposed on one side and the other side, respectively, of a first line L1 that connects between the center of the first axis AX1 and the center of the fourth axis AX4 and that serves as the boundary. In the embodiment, the second axis AX2 and the third axis AX3 are disposed on the lower side and the upper side, respectively, of the first line L1 which serves as the boundary. With such an arrangement, the center of the primary pulley 41 can be disposed below the crankshaft of the internal combustion engine 2. Thus, the position of arrangement of the continuously variable speed change mechanism 40 in the automatic transmission 10 can be lowered compared to a case where the center of the primary pulley 41 is disposed coaxially with the crankshaft.

In the automatic transmission 10 according to the embodiment, in addition, a second line L2 that connects between the center of the second axis AX2 and the center of the third axis AX3 intersects the first line L1 at a crossing point X between the center of the first axis AX1 and the center of the fourth axis AX4 as viewed in the axial direction. Therefore, the third axis AX3 can be disposed in rear of the first axis AX1, and thus the secondary pulley 42 which is disposed on the third axis AX3 can be disposed so as not to project forward of the internal combustion engine 2 which is drivably coupled to the first axis AX1. Consequently, the forward projection of the automatic transmission 10 can be reduced, which allows the automatic transmission 10 to provide improved mountability to the vehicle 1 in spite of including the continuously variable speed change mechanism 40.

The ECU 11 includes a CPU, a ROM that stores a processing program, a RAM that temporarily stores data, input and output ports, and a communication port, for example, and is configured to output various types of signals, such as a control signal for the hydraulic control device 12, from the output port. In addition, the ECU 11 switches the automatic transmission 10 among the forward mode, the reverse mode, and so forth as appropriate on the basis of the travel stop state of the vehicle 1 or the intention of the driver for acceleration and deceleration.

The hydraulic control device 12 is constituted of a valve body, for example, and is capable of generating a line pressure, a modulator pressure, and so forth from a hydraulic pressure supplied from an oil pump (not illustrated) to supply and discharge a hydraulic pressure for controlling the first clutch C1 and the first brake B1 on the basis of a control signal from the ECU 11.

In the automatic transmission 10 configured as described above, the first clutch C1 and the first brake B1 illustrated in the skeleton diagram of FIG. 1 are engaged and disengaged in combinations indicated in the engagement table of FIG. 2B to establish one of the forward mode and the reverse mode or a neutral state is established when neither of the modes is selected.

Next, operation of the automatic transmission 10 will be described with reference to FIGS. 1, 2A, and 2B.

In the case where a drive (D) range is selected as a shift range, the ECU 11 selects the forward mode. The ECU 11 controls the hydraulic control device 12 so as to supply and discharge a hydraulic pressure such that the first clutch C1 is engaged and the first brake B1 is disengaged as illustrated in FIG. 2B. Consequently, in the automatic transmission 10, input rotation from the input shaft 31 is input from the transfer mechanism 90 to the input shaft 47 of the continuously variable speed change mechanism 40 via the first clutch C1. The continuously variable speed change mechanism 40 performs shifting as appropriate, and rotation is transferred from the intermediate shaft 60 to rotate the left and right drive shafts 73 in the forward direction via the differential device 70.

Next, in the case where a reverse (R) range is selected as the shift range, the ECU 11 selects the reverse mode. The ECU 11 controls the hydraulic control device 12 so as to supply and discharge a hydraulic pressure such that the first clutch C1 is disengaged and the first brake B1 is disengaged as illustrated in FIG. 2B. Consequently, in the automatic transmission 10, input rotation from the input shaft 31 is input from the transfer mechanism 90 to the input shaft 47 of the continuously variable speed change mechanism 40 after being reversed via the planetary gear DP1. The continuously variable speed change mechanism 40 performs shifting as appropriate, and rotation is transferred from the intermediate shaft 60 to rotate the left and right drive shafts 73 in the reverse direction via the differential device 70.

In the automatic transmission 10 according to the embodiment, as has been described above, the center of the second axis AX2 and the center of the third axis AX3 are disposed on one side and the other side, respectively, of the first line L1 which connects between the center of the first axis AX1 and the center of the fourth axis AX4 and which serves as the boundary as viewed in the axial direction. Thus, the second axis AX2 or the third axis AX3 can be disposed below the first axis AX1. Therefore, the center of the primary pulley 41 or the secondary pulley 42 can be disposed below the crankshaft of the internal combustion engine 2. Thus, the position of arrangement of the continuously variable speed change mechanism 40 in the automatic transmission 10 can be lowered compared to a case where the center of the primary pulley 41 or the secondary pulley 42 is disposed coaxially with the crankshaft. Consequently, the upward projection of the automatic transmission 10 can be reduced, which allows the automatic transmission 10 to provide improved mountability to the vehicle 1 in spite of including the continuously variable speed change mechanism 40.

In the automatic transmission 10 according to the embodiment, in addition, the rotational direction of the drive shafts 73 and the rotational direction around the second axis AX2 and the third axis AX3 are opposite to each other. Therefore, it is difficult that lubricating oil splashed by the primary pulley 41 which is disposed on the second axis AX2 is scattered in the direction of the drive shafts 73. Consequently, the stirring resistance of the drive shafts 73 against the lubricating oil can be reduced, which can improve the fuel efficiency.

In particular, in the automatic transmission 10 according to the embodiment, as illustrated in FIG. 2A, the center of the second axis AX2 and the center of the third axis AX3 are disposed on the lower side and the upper side, respectively, of the first line L1 which connects between the center of the first axis AX1 and the center of the fourth axis AX4 and which serves as the boundary as viewed in the axial direction. Therefore, the forward/reverse switching mechanism 50 which is a heavy object disposed on the second axis AX2 is disposed in the lower portion of the automatic transmission 10. Thus, the center of gravity of the automatic transmission 10 can be lowered to improve the travel stability of the vehicle 1 on which the automatic transmission 10 is mounted. With the automatic transmission 10 according to the embodiment, in addition, the mountability of the automatic transmission 10 to the vehicle 1 can be improved by suppressing the upward projection of the automatic transmission 10 even if the secondary pulley 42 which is disposed on the third axis AX3 is disposed above the primary pulley 41 which is disposed on the second axis AX2, and stirring of lubricating oil by the secondary pulley 42, the speed of which is increased during high-speed travel, can be suppressed. Consequently, the stirring resistance against the lubricating oil during high-speed travel can be reduced, which can improve the fuel efficiency.

In addition, the automatic transmission 10 according to the embodiment includes the forward/reverse switching mechanism 50 which is disposed on the second axis AX2 and which is capable of switching rotation input from the input shaft 31 between forward rotation and reverse rotation and outputting the resultant rotation to the primary pulley 41. Therefore, the drive force of the internal combustion engine 2 which is input to the input shaft 31 can be switched between forward rotation and reverse rotation, and thus the vehicle 1 can be switched between forward travel and reverse travel.

In the automatic transmission 10 according to the embodiment, in addition, the forward/reverse switching mechanism 50 is disposed on the second axis AX2, and has: the sun gear S1 which is drivably coupled to the input shaft 31, the carrier CR1 which is drivably coupled to the primary pulley 41, and the ring gear R1 which can be made rotationally stationary; the first clutch C1 which is capable of establishing the forward mode in which forward rotation is transferred with the input shaft 31 and the primary pulley 41 connected to each other via the carrier CR1 when the first clutch C1 is engaged; and the first brake B1 which is capable of establishing the reverse mode in which reverse rotation is transferred with the input shaft 31 and the primary pulley 41 connected to each other via the planetary gear DP1 by making the ring gear R1 rotationally stationary when the first brake B1 is engaged. Therefore, switching between forward travel and reverse travel can be achieved by a relatively simple configuration, namely the planetary gear DP1, the first clutch C1, and the first brake B1.

### Second Embodiment

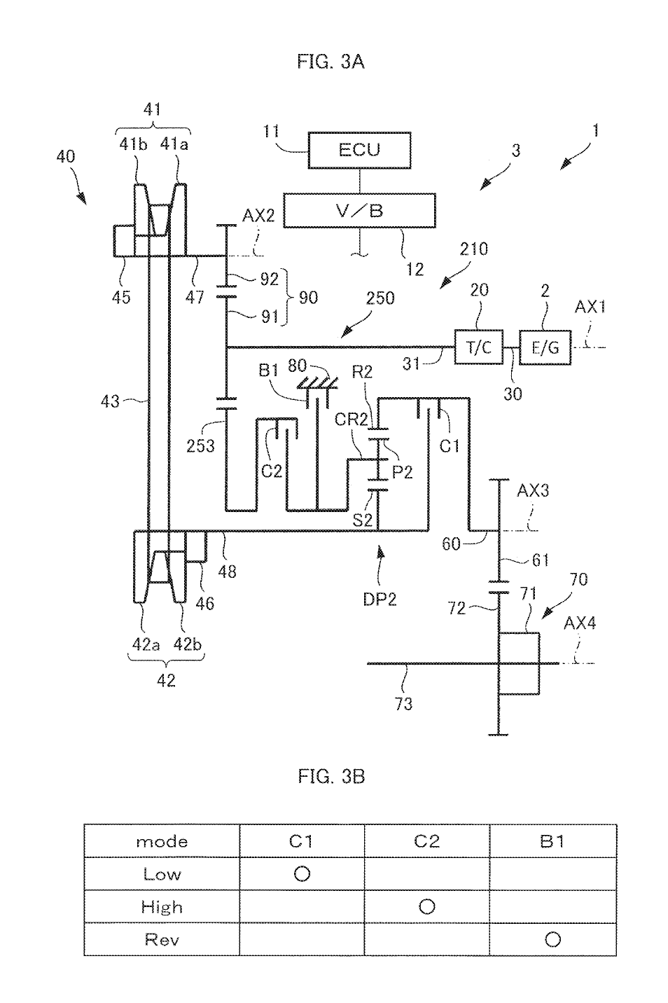

Next, an automatic transmission 210 according to a second embodiment will be described with reference to FIGS. 3A and 3B. This embodiment is different from the first embodiment in that a speed change gear mechanism 250 is disposed in place of the forward/reverse switching mechanism 50. However, the other components are the same as those according to the first embodiment, and thus the same reference numerals are given to such components to omit detailed description.

In the embodiment, the driven gear 92 of the transfer mechanism 90 and the primary pulley 41 and the input shaft 47 of the continuously variable speed change mechanism 40 are disposed on the second axis AX2. In addition, the secondary pulley 42 and the output shaft 48 of the continuously variable speed change mechanism 40, the speed change gear mechanism 250, the intermediate shaft 60, and the output gear 61 are disposed on the third axis AX3.

The speed change gear mechanism 250 includes a planetary gear DP2, the first clutch (first engagement element) C1, a second clutch (second engagement element) C2, the first brake (third engagement element) B1, and an input gear 253 meshed with the drive gear 91 of the transfer mechanism 90, and can change the speed of rotation of the drive shafts 73. In addition, the speed change gear mechanism 250 also functions as a forward/reverse switching device configured to switch rotational direction in accordance with the travel direction of the vehicle 1 and transfer the resultant rotation.

The planetary gear DP2 is constituted of a single-pinion planetary gear that has a sun gear (first rotary element) S2 drivably coupled to the secondary pulley 42, a carrier (second rotary element) CR2 which is drivably coupled to the second clutch C2 and to which rotation of the input shaft 31 can be input, and a ring gear (third rotary element) R2 drivably coupled to the drive shafts 73 via the intermediate shaft 60. The carrier CR2 rotatably supports the pinion P2 which is meshed with the sun gear S2 and the ring gear R2, and can be made stationary with respect to the transmission case 80 via the first brake B1.

The first clutch C1 is disposed between the output shaft 48 of the continuously variable speed change mechanism 40 and the intermediate shaft 60. When the first clutch C1 is engaged, the output shaft 48 and the intermediate shaft 60 are directly coupled to each other to form a transfer path for a low-speed mode through only the continuously variable speed change mechanism 40.

The second clutch C2 is disposed between the input gear 253 and the carrier CR2. When the second clutch C2 is engaged, the planetary gear DP2 combines input rotation input from the input shaft 31 via the input gear 253 and input rotation input from the continuously variable speed change mechanism 40 to output rotational drive for a high-speed mode.

When the first brake B1 is engaged, input rotation input from the continuously variable speed change mechanism 40 rotates the intermediate shaft 60 in reverse via the planetary gear DP2 to form a transfer path for a reverse mode.

In the automatic transmission 210 configured as described above, the first clutch C1, the second clutch C2, and the first brake B1 illustrated in the skeleton diagram of FIG. 3A are engaged and disengaged in combinations indicated in the engagement table of FIG. 3B to establish one of the forward low-speed mode, the forward high-speed mode, and the reverse mode or a neutral state is established when none of the modes is selected.

As in the first embodiment, in the automatic transmission 210 according to the embodiment, the center of the second axis AX2 and the center of the third axis AX3 are disposed on one side and the other side, respectively, of the first line L1 which connects between the center of the first axis AX1 and the center of the fourth axis AX4 and which serves as the boundary as viewed in the axial direction. Thus, the second axis AX2 or the third axis AX3 can be disposed below the first axis AX1. Therefore, the upward projection of the automatic transmission 210 can be reduced, which allows the automatic transmission 10 to provide improved mountability to the vehicle 1 in spite of including the continuously variable speed change mechanism 40.

In addition, the automatic transmission 210 according to the embodiment includes: the planetary gear DP2 which is disposed on the third axis AX3, which has the sun gear S2 which is drivably coupled to the secondary pulley 42, the carrier CR2 to which rotation of the input shaft 31 can be input, and the ring gear R2 which is drivably coupled to the drive shafts 73, and which can change the speed of rotation of the drive shafts 73; the first clutch C1 which is capable of establishing the low-speed mode in which rotation is transferred with the input shaft 31 and the drive shafts 73 connected to each other via the continuously variable speed change mechanism 40 when the first clutch C1 is engaged; and the second clutch C2 which is capable of establishing the high-speed mode in which rotation is transferred at a higher speed than when the first clutch C1 is engaged with the input shaft 31 and the drive shafts 73 connected to each other via the planetary gear DP2 and the continuously variable speed change mechanism 40 when the second clutch C2 is engaged. Therefore, in the high-speed mode, power transfer is performed with the respective power transfer paths of the planetary gear DP2 and the continuously variable speed change mechanism 40 connected in parallel with each other, and thus a torque load on the continuously variable speed change mechanism 40 can be reduced compared to a case where the continuously variable speed change mechanism 40 is used alone. Consequently, it is possible to improve the fuel efficiency, and to reduce the size of the continuously variable speed change mechanism 40.

### Third Embodiment

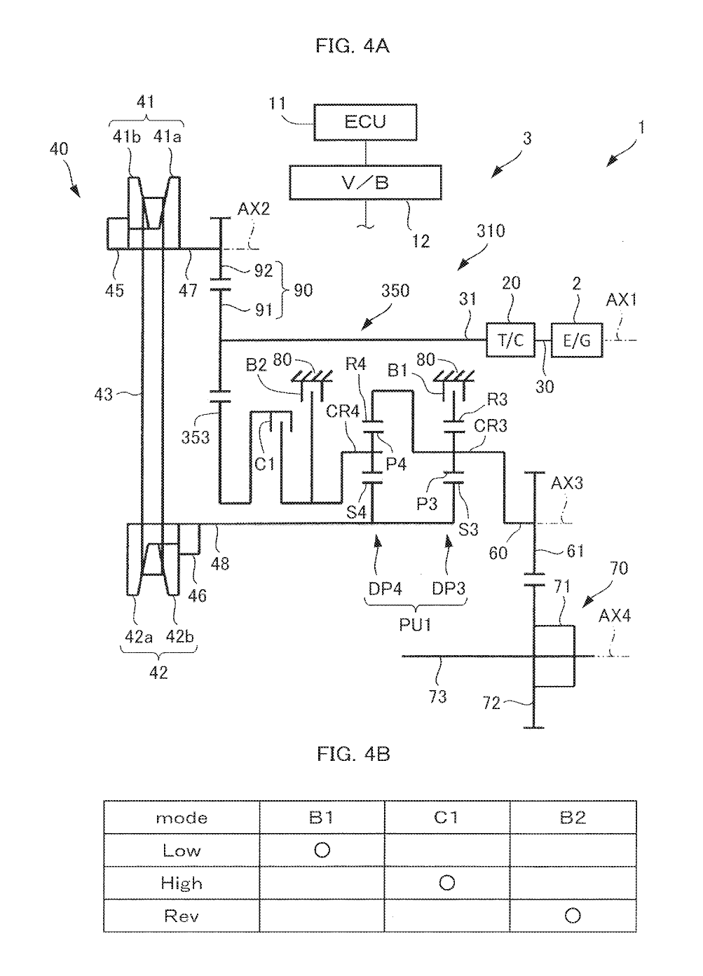

Next, an automatic transmission 310 according to a third embodiment will be described with reference to FIGS. 4A and 4B. This embodiment is different from the second embodiment in that a speed change gear mechanism 350 has a planetary gear unit PU1. However, the other components are the same as those according to the second embodiment, and thus the same reference numerals are given to such components to omit detailed description.

The speed change gear mechanism 350 according to the embodiment includes the planetary gear unit PU1, the first brake (first engagement element) B1, the first clutch (second engagement element) C1, a second brake (third engagement element) B2, and an input gear 353 meshed with the drive gear 91 of the transfer mechanism 90, and can change the speed of rotation of the drive shafts 73. In addition, the speed change gear mechanism 350 also functions as a forward/reverse switching device configured to switch rotational direction in accordance with the travel direction of the vehicle 1 and transfer the resultant rotation. The planetary gear unit PU1 includes two single-pinion planetary gears, namely a planetary gear DP3 and a planetary gear DP4, and is a Simpson planetary set.

The planetary gear DP3 is constituted of a single-pinion planetary gear that has a sun gear (first rotary element) S3 drivably coupled to the secondary pulley 42, a carrier (third rotary element) CR3 drivably coupled to the drive shafts 73 via the intermediate shaft 60, and a ring gear (fourth rotary element) R3 that can be made rotationally stationary by the first brake B1. The carrier CR3 rotatably supports a pinion P3 meshed with the sun gear S3 and the ring gear R3.

The planetary gear DP4 is constituted of a single-pinion planetary gear that has a sun gear (first rotary element) S4 drivably coupled to the secondary pulley 42, a carrier (second rotary element) CR4 which is drivably coupled to the first clutch C1 and to which rotation of the input shaft 31 can be input, and a ring gear (third rotary element) R4 drivably coupled to the carrier CR3 and the drive shafts 73. The carrier CR4 rotatably supports a pinion P4 meshed with the sun gear S4 and the ring gear R4, and can be made stationary with respect to the transmission case 80 via the second brake B2.

The first brake B1 is coupled to the ring gear R3. When the first brake B1 is engaged, a transfer path for the low-speed mode in which output of the continuously variable speed change mechanism 40 is decelerated by the planetary gear DP3 is formed.

The first clutch C1 is disposed between the input gear 353 and the carrier CR4. When the first clutch C1 is engaged, the planetary gear DP4 combines input rotation input from the input shaft 31 via the input gear 353 and input rotation input from the continuously variable speed change mechanism 40 to output rotational drive for a high-speed mode.

When the second brake B2 is engaged, input rotation input from the continuously variable speed change mechanism 40 rotates the intermediate shaft 60 in reverse via the planetary gear DP4 to form a transfer path for a reverse mode.

In the automatic transmission 310 configured as described above, the first brake B1, the first clutch C1, and the second brake B2 illustrated in the skeleton diagram of FIG. 4A are engaged and disengaged in combinations indicated in the engagement table of FIG. 4B to establish one of the forward low-speed mode, the forward high-speed mode, and the reverse mode or a neutral state is established when none of the modes is selected.

As in the first embodiment, in the automatic transmission 310 according to the embodiment, the center of the second axis AX2 and the center of the third axis AX3 are disposed on one side and the other side, respectively, of the first line L1 which connects between the center of the first axis AX1 and the center of the fourth axis AX4 and which serves as the boundary as viewed in the axial direction. Thus, the second axis AX2 or the third axis AX3 can be disposed below the first axis AX1. Therefore, the upward projection of the automatic transmission 310 can be reduced, which allows the automatic transmission 10 to provide improved mountability to the vehicle 1 in spite of including the continuously variable speed change mechanism 40.

In addition, the automatic transmission 310 according to the embodiment includes: the planetary gear unit PU1 which is disposed on the third axis AX3, which has the sun gears S3 and S4 which are drivably coupled to the secondary pulley 42, the carrier CR4 to which rotation of the input shaft 31 can be input, the carrier CR3 and the ring gear R4 which are drivably coupled to the drive shafts 73, and the ring gear R3 which can be made rotationally stationary, and which can change the speed of rotation of the drive shafts 73; the first brake B1 which is capable of establishing the low-speed mode in which rotation is transferred with the input shaft 31 and the drive shafts 73 connected to each other via the planetary gear unit PU1 and the continuously variable speed change mechanism 40 by making the ring gear R3 rotationally stationary when the first brake B1 is engaged; and the first clutch C1 which is capable of establishing the high-speed mode in which rotation is transferred at a higher speed than when the first brake B1 is engaged with the input shaft 31 and the drive shafts 73 connected to each other via the planetary gear unit PU1 and the continuously variable speed change mechanism 40 when the first clutch C1 is engaged. Therefore, in the high-speed mode, power transfer is performed with the respective power transfer paths of the planetary gear DP4 and the continuously variable speed change mechanism 40 connected in parallel with each other, and thus a torque load on the continuously variable speed change mechanism 40 can be reduced compared to a case where the continuously variable speed change mechanism 40 is used alone. Consequently, it is possible to improve the fuel efficiency, and to reduce the size of the continuously variable speed change mechanism 40.

### Fourth Embodiment

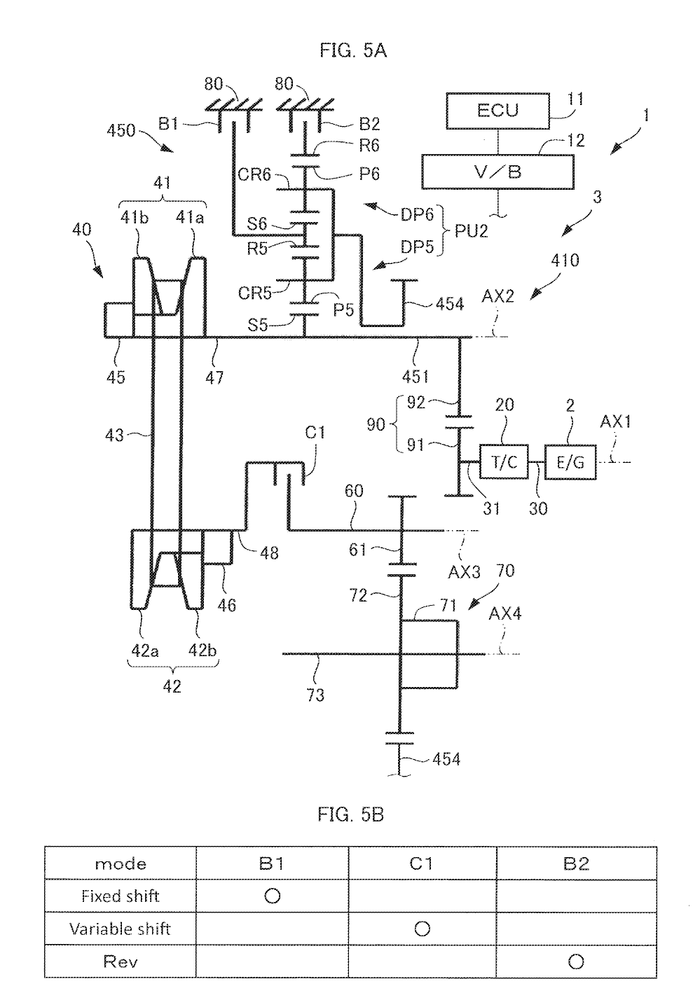

Next, an automatic transmission 410 according to a fourth embodiment will be described with reference to FIGS. 5A and 5B. This embodiment is different from the first embodiment in that a speed change gear mechanism 450 is disposed in place of the forward/reverse switching mechanism 50. However, the other components are the same as those according to the first embodiment, and thus the same reference numerals are given to such components to omit detailed description.

In the embodiment, the driven gear 92 of the transfer mechanism 90, the speed change gear mechanism 450, and the primary pulley 41 and the input shaft 47 of the continuously variable speed change mechanism 40 are disposed on the second axis AX2. In addition, the secondary pulley 42 and the output shaft 48 of the continuously variable speed change mechanism 40, the first clutch C1, the intermediate shaft 60, and the output gear 61 are disposed on the third axis AX3.

The speed change gear mechanism 450 according to the embodiment includes a planetary gear unit PU2, the first brake (first engagement element) B1, the first clutch (second engagement element) C1, the second brake (third engagement element) B2, and a counter gear 454 meshed with the mount ring gear 72, and can change the speed of rotation of the drive shafts 73. In addition, the speed change gear mechanism 450 also functions as a forward/reverse switching device configured to switch the rotational direction in accordance with the travel direction of the vehicle 1 and transfer the resultant rotation. The planetary gear unit PU2 includes two single-pinion planetary gears, namely a planetary gear DP5 and a planetary gear DP6 disposed on the outer peripheral side of the planetary gear DP5 in the radial direction.

The planetary gear DP5 which is disposed on the inner peripheral side is constituted of a single-pinion planetary gear that has a sun gear (first rotary element) S5 drivably coupled to the primary pulley 41, a carrier (second rotary element) CR5 drivably coupled to the counter gear 454, and a ring gear (third rotary element) R3 that can be made rotationally stationary by the first brake B1. The carrier CR5 rotatably supports a pinion P5 meshed with the sun gear S5 and the ring gear R5.

The planetary gear DP6 which is disposed on the outer peripheral side of the planetary gear DP5 is constituted of a single-pinion planetary gear that has a sun gear (fourth rotary element) S6 drivably coupled to the ring gear R5, a carrier (fifth rotary element) CR6 drivably coupled to the carrier CR5 and the counter gear 454, and a ring gear (sixth rotary element) R6 that can be made rotationally stationary by the second brake B2. The carrier CR6 rotatably supports a pinion P6 meshed with the sun gear S6 and the ring gear R6.

The planetary gear unit PU2 is obtained by combining the single-pinion planetary gear DP5 on the inner peripheral side and the single-pinion planetary gear DP6 on the outer peripheral side in a two-storied structure, and configured to have: the sun gear S5; an integral intermediate gear in which the ring gear R5 is formed on the inner peripheral side and the sun gear S6 is formed on the outer peripheral side; the ring gear R6; and a common carrier that rotatably supports the pinion P5 and the pinion P6. The pinion P5 is meshed with the sun gear S5 and the ring gear R5, and the pinion P6 being meshed with the sun gear S6 and the ring gear R6 and disposed so as to be at least partially overlap the pinion P5 in the axial direction as viewed in the radial direction.

The first brake B1 is coupled to the ring gear R5 and the sun gear S6. When the first brake B1 is engaged, a transfer path for a fixed gear mode in which input rotation input from the input shaft 31 is decelerated via the planetary gear DP5 and output from the drive shafts 73 via the counter gear 454 is formed.

The first clutch C1 is disposed on the third axis AX3 between the output shaft 48 of the continuously variable speed change mechanism 40 and the intermediate shaft 60. When the first clutch C1 is engaged, the output shaft 48 and the intermediate shaft 60 are directly coupled to each other to form a transfer path for a continuously variable speed change mode through only the continuously variable speed change mechanism 40.

When the second brake B2 is engaged, input rotation input from the input shaft 31 rotates the counter gear 454 in reverse via the planetary gear unit PU2 to form a transfer path for the reverse mode.

In the automatic transmission 410 configured as described above, the first brake B1, the first clutch C1, and the second brake B2 illustrated in the skeleton diagram of FIG. 5A are engaged and disengaged in combinations indicated in the engagement table of FIG. 5B to establish one of the forward fixed gear (fixed shift) mode, the forward continuously variable speed change (continuously variable shift) mode, and the reverse mode or a neutral state is established when none of the modes is selected.

As in the first embodiment, in the automatic transmission 410 according to the embodiment, the center of the second axis AX2 and the center of the third axis AX3 are disposed on one side and the other side, respectively, of the first line L1 which connects between the center of the first axis AX1 and the center of the fourth axis AX4 and which serves as the boundary as viewed in the axial direction. Thus, the second axis AX2 or the third axis AX3 can be disposed below the first axis AX1. Therefore, the upward projection of the automatic transmission 410 can be reduced, which allows the automatic transmission 10 to provide improved mountability to the vehicle 1 in spite of including the continuously variable speed change mechanism 40.

In addition, the automatic transmission 410 according to the embodiment includes: the planetary gear DP5 which is disposed on the second axis AX2, which has the sun gear S5 which is drivably coupled to the input shaft 31, the carrier CR5 which is drivably coupled to the drive shafts 73, and the ring gear R5 which can be made rotationally stationary, and which can change the speed of rotation of the drive shafts 73; the first brake B1 which is capable of establishing the fixed gear mode in which rotation is transferred with the input shaft 31 and the drive shafts 73 connected to each other via the planetary gear DP5 by making the ring gear R5 rotationally stationary when the first brake B1 is engaged; and the first clutch C1 which is capable of establishing the continuously variable speed change mode in which rotation is transferred with the input shaft 31 and the drive shafts 73 connected to each other via the continuously variable speed change mechanism 40 when the first clutch C1 is engaged. Therefore, the vehicle can travel in the fixed gear mode during travel at a low speed when the load torque is relatively large and travel in the continuously variable speed change mode during travel at a high speed when the load torque is relatively small, which can improve the fuel efficiency.

In addition, the automatic transmission 410 according to the embodiment includes: the planetary gear unit PU2 which has the planetary gear DP5, the sun gear S6 which is drivably coupled to the ring gear R5 and which can be made rotationally stationary by the first brake B1, the carrier CR6 which is drivably coupled to the carrier CR5 and the drive shafts 73, and the ring gear R6 which can be made rotationally stationary, and which can change the speed of rotation of the drive shafts 7, in which the sun gear S6, the carrier CR6, and the ring gear R6 are disposed on the second axis AX2; and the second brake B2 capable of establishing the reverse mode in which reverse rotation is transferred with the input shaft 31 and the drive shafts 73 connected to each other via the planetary gear unit PU2 by making the ring gear R6 rotationally stationary when the second brake B2 is engaged. Therefore, the planetary gear DP5 and the planetary gear DP6 are disposed so as to overlap each other in the radial direction. Thus, the length of the automatic transmission 410 in the axial direction can be shortened to achieve a size reduction.

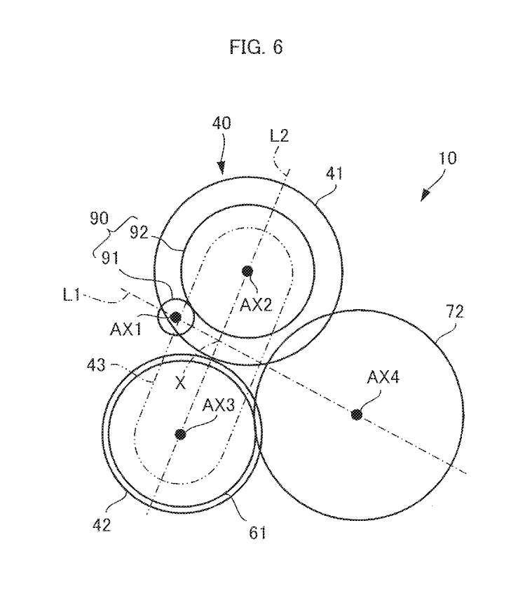

In the first to fourth embodiments discussed above, the center of the second axis AX2 and the center of the third axis AX3 are disposed on the lower side and the upper side, respectively, of the first line L1 which connects between the center of the first axis AX1 and the center of the fourth axis AX4 and which serves as the boundary as viewed in the axial direction. However, the present disclosure is not limited thereto. For example, as illustrated in FIG. 6, the center of the third axis AX3 and the center of the fourth axis AX4 may be disposed on the lower side and the upper side, respectively, of the first line L1 which serves as the boundary. In this case as well, the upward projection of the automatic transmission 10 can be reduced, which allows the automatic transmission 10 to provide improved mountability to the vehicle 1 in spite of including the continuously variable speed change mechanism 40. In this case, in addition, the speed change gear mechanism 250, 350 which is a heavy object is disposed in the lower portion of the automatic transmission 10 when the speed change gear mechanism 250, 350 is disposed on the third axis AX3 as in the second and third embodiments. Thus, the center of gravity of the automatic transmission 10 can be lowered to improve the travel stability of the vehicle 1 on which the automatic transmission 10 is mounted.

In the first to fourth embodiments discussed above, in addition, the automatic transmission 10, 210, 310, 410 includes the torque converter 20 by way of example. However, the present disclosure is not limited thereto. For example, the automatic transmission 10, 210, 310, 410 may include a starting clutch. That is, the automatic transmission 10, 210, 310, 410 may include any component that may adjust rotation from the internal combustion engine 2 to be input to the automatic transmission 10, 210, 310, 410 at the time of starting or the like.

In the first to fourth embodiments discussed above, in addition, the belt-type continuously variable speed change mechanism 40 is provided as the continuously variable speed change mechanism 40 by way of example. However, the present disclosure is not limited thereto. For example, a toroidal-type continuously variable speed change mechanism or a cone-ring-type continuously variable speed change mechanism may be provided as the continuously variable speed change mechanism 40. That is, any component that can continuously change the speed ratio may be provided as the continuously variable speed change mechanism 40.

In the first to fourth embodiments discussed above, in addition, the automatic transmission 10, 210, 310, 410 uses the internal combustion engine 2 as the drive source. However, the present disclosure is not limited thereto. For example, a combination of a motor and an internal combustion engine or a motor alone may be used as the drive source. That is, the automatic transmission 10, 210, 310, 410 may be used for a hybrid vehicle, an electric vehicle, or the like. In addition, the drive source is not limited to such examples, and may be any component that can be used as a drive source to which an automatic transmission may be connected.

The embodiment includes at least the following configuration. The embodiment provides an automatic transmission (10, 210, 310, 410) including: an input member (30, 31) disposed on a first axis (AX1) and drivably coupled to a drive source (2); a transfer mechanism (90) that is provided between the first axis (AX1) and a second axis (AX2) that is parallel to the first axis (AX1) and that transfers rotation around the first axis (AX1) to the second axis (AX2); a continuously variable speed change mechanism (40) that is capable of continuously changing a speed ratio and has a primary pulley (41) disposed on the second axis (AX2), a secondary pulley (42) disposed on a third axis (AX3) that is parallel to the second axis (AX2), and a belt (43) wound around the two pulleys (41, 42); and an output member (73) disposed on a fourth axis (AX4) that is parallel to the third axis (AX3) and meshed with a drive pinion gear (61) on the third axis (AX3) to output rotation at a changed speed, in which a center of the second axis (AX2) and a center of the third axis (AX3) are disposed on one side and the other side, respectively, of a first line (L1) that connects between a center of the first axis (AX1) and a center of the fourth axis (AX4) and that serves as a boundary as viewed in an axial direction.

In this configuration, the center of the second axis (AX2) and the center of the third axis (AX3) are disposed on one side and the other side, respectively, of the first line (L1) which connects between the center of the first axis (AX1) and the center of the fourth axis (AX4) and which serves as the boundary as viewed in the axial direction. Thus, the center of the second axis (AX2) or the center of the third axis (AX3) can be disposed below the first axis (AX1). Therefore, the center of either the primary pulley (41) or the secondary pulley (42) can be disposed below a drive shaft of the drive source (2). Thus, the position of arrangement of the continuously variable speed change mechanism (40) in the automatic transmission (10, 210, 310, 410) can be lowered compared to a case where the center of either the primary pulley (41) or the secondary pulley (42) is disposed coaxially with the drive shaft of the drive source (2). The center of any of the primary pulley (41) and the secondary pulley (42) may be disposed below the drive shaft of the drive source (2). Consequently, the upward projection of the automatic transmission (10, 210, 310, 410) can be reduced, which allows the automatic transmission (10, 210, 310, 410) to provide improved mountability to the vehicle (1) in spite of including the continuously variable speed change mechanism (40). In addition, the rotational direction of the output member (73) and the rotational direction around the second axis (AX2) and the third axis (AX3) are opposite to each other. Therefore, it is difficult that lubricating oil splashed by a pulley (41, 42) disposed on the second axis (AX2) or the third axis (AX3) disposed on the lower side is scattered in the direction of the output shaft (73). Consequently, the stirring resistance of the output member (73) against the lubricating oil can be reduced, which can improve the fuel efficiency.

In the automatic transmission (10, 210, 310, 410) according to the embodiment, in addition, the center of the second axis (AX2) and the center of the third axis (AX3) are disposed on a lower side and an upper side, respectively, of the first line (L1) which connects between the center of the first axis (AX1) and the center of the fourth axis (AX4) and which serves as the boundary as viewed in the axial direction. In this configuration, the forward/reverse switching mechanism (50), the speed change gear mechanism (450), or the like which is a heavy object disposed on the second axis (AX2) is disposed in the lower portion of the automatic transmission (10, 210, 310, 410). Thus, the center of gravity of the automatic transmission (10, 210, 310, 410) can be lowered to improve the travel stability of the vehicle (1) on which the automatic transmission (10, 210, 310, 410) is mounted. In addition, the mountability of the automatic transmission (10, 210, 310, 410) to the vehicle (1) can be improved by suppressing the upward projection of the automatic transmission (10, 210, 310, 410) even if the secondary pulley (42) which is disposed on the third axis (AX3) is disposed above the primary pulley (41) which is disposed on the second axis (AX2), and stirring of lubricating oil by the secondary pulley (42), the speed of which is increased during high-speed travel, can be suppressed. Consequently, the stirring resistance against the lubricating oil during high-speed travel can be reduced, which can improve the fuel efficiency.

In the automatic transmission (10, 210, 310, 410) according to the embodiment, in addition, the center of the third axis (AX3) and the center of the second axis (AX2) are disposed on a lower side and an upper side, respectively, of the first line (L1) which connects between the center of the first axis (AX1) and the center of the fourth axis (AX4) and which serves as the boundary as viewed in the axial direction. With this configuration, the upward projection of the automatic transmission (10, 210, 310, 410) can be reduced, which allows the automatic transmission (10, 210, 310, 410) to provide improved mountability to the vehicle (1) in spite of including the continuously variable speed change mechanism (40). In this case, in addition, the speed change gear mechanism (250, 350) is disposed in the lower portion of the automatic transmission (10, 210, 310, 410) when the speed change gear mechanism (250, 350) which is a heavy object, for example, is disposed on the third axis (AX3). Thus, the center of gravity of the automatic transmission (10, 210, 310, 410) can be lowered to improve the travel stability of the vehicle (1) on which the automatic transmission (10, 210, 310, 410) is mounted.

In the automatic transmission (10, 210, 310, 410) according to the embodiment, in addition, a second line (L2) that connects between the center of the second axis (AX2) and the center of the third axis (AX3) intersects the first line (L1) between the center of the first axis (AX1) and the center of the fourth axis (AX4) as viewed in the axial direction. With this configuration, the third axis (AX3) can be disposed in rear of the first axis (AX1), and thus the secondary pulley (42) which is disposed on the third axis (AX3) can be disposed so as not to project forward of the drive source (2) which is drivably coupled to the first axis (AX1). Consequently, the forward projection of the automatic transmission (10, 210, 310, 410) can be reduced, which allows the automatic transmission (10, 210, 310, 410) to provide improved mountability to the vehicle (1) in spite of including the continuously variable speed change mechanism (40).

In addition, the automatic transmission (10) according to the embodiment further includes a forward/reverse switching mechanism (50) disposed on the second axis (AX2) and capable of switching rotation input from the input member (30, 31) between forward rotation and reverse rotation and outputting the resultant rotation to the primary pulley (41). With this configuration, the drive force of the drive source (2) which is input to the input shaft (30, 31) can be switched between forward rotation and reverse rotation, and thus the vehicle (1) can be switched between forward travel and reverse travel.

In the automatic transmission (10) according to the embodiment, in addition, the forward/reverse switching mechanism (50) has: a planetary gear (DP1) that is disposed on the second axis (AX2), that has a first rotary element (S1) drivably coupled to the input member (30, 31), a second rotary element (CR1) drivably coupled to the primary pulley (41), and a third rotary element (R1) capable of being made rotationally stationary, and that can change a speed of rotation of the output member (73); a first engagement element (C1) capable of establishing a forward mode in which forward rotation is transferred with the input member (30, 31) and the primary pulley (41) connected to each other via the second rotary element (CR1) when the first engagement element (C1) is engaged; and a second engagement element (B1) capable of establishing a reverse mode in which reverse rotation is transferred with the input member (30, 31) and the primary pulley (41) connected to each other via the planetary gear (DP1) by making the third rotary element (R1) rotationally stationary when the second engagement element (B1) is engaged. With this configuration, switching between forward travel and reverse travel can be achieved by a relatively simple configuration, namely the planetary gear (DP1), the first engagement element (C1), and the second engagement element (B1).

In addition, the automatic transmission (210) according to the embodiment further includes: a planetary gear (DP2) that is disposed on the third axis (AX3), that has a first rotary element (S2) drivably coupled to the secondary pulley (42), a second rotary element (CR2) to which rotation of the input member (30, 31) can be input, and a third rotary element (R2) drivably coupled to the output member (73), and that can change a speed of rotation of the output member (73); a first engagement element (C1) capable of establishing a low-speed mode in which rotation is transferred with the input member (30, 31) and the output member (73) connected to each other via the continuously variable speed change mechanism (40) when the first engagement element (C1) is engaged; and a second engagement element (C2) capable of establishing a high-speed mode in which rotation is transferred at a higher speed than when the first engagement element (C1) is engaged with the input member (30, 31) and the output member (73) connected to each other via the planetary gear (DP2) and the continuously variable speed change mechanism (40) when the second engagement element (C2) is engaged. With this configuration, in the high-speed mode, power transfer is performed with the respective power transfer paths of the planetary gear (DP2) and the continuously variable speed change mechanism (40) connected in parallel with each other, and thus a torque load on the continuously variable speed change mechanism (40) can be reduced compared to a case where the continuously variable speed change mechanism (40) is used alone. Consequently, it is possible to improve the fuel efficiency, and to reduce the size of the continuously variable speed change mechanism (40).

In addition, the automatic transmission (310) according to the embodiment further includes: a planetary gear unit (PU1) that is disposed on the third axis (AX3), that has a first rotary element (S3, S4) drivably coupled to the secondary pulley (42), a second rotary element (CR4) to which rotation of the input member (30, 31) can be input, a third rotary element (CR3, R4) drivably coupled to the output member (73), and a fourth rotary element (R3) capable of being made rotationally stationary, and that can change a speed of rotation of the output member (73); a first engagement element capable of establishing a low-speed mode in which rotation is transferred with the input member (30, 31) and the output member (73) connected to each other via the planetary gear unit (PU1) and the continuously variable speed change mechanism (40) by making the fourth rotary element (R3) rotationally stationary when the first engagement element is engaged; and a second engagement element (C1) capable of establishing a high-speed mode in which rotation is transferred at a higher speed than when the first engagement element (B1) is engaged with the input member (30, 31) and the output member (73) connected to each other via the planetary gear unit (PU1) and the continuously variable speed change mechanism (40) when the second engagement element (C1) is engaged. With this configuration, in the high-speed mode, power transfer is performed with the respective power transfer paths of the planetary gear (DP4) and the continuously variable speed change mechanism (40) connected in parallel with each other, and thus a torque load on the continuously variable speed change mechanism (40) can be reduced compared to a case where the continuously variable speed change mechanism (40) is used alone. Consequently, it is possible to improve the fuel efficiency, and to reduce the size of the continuously variable speed change mechanism (40).

In addition, the automatic transmission (410) according to the embodiment further includes: a planetary gear (DP5) that is disposed on the second axis (AX2), that has a first rotary element (S5) drivably coupled to the input member (30, 31), a second rotary element (CR5) drivably coupled to the output member (73), and a third rotary element (R5) capable of being made rotationally stationary, and that can change a speed of rotation of the output member (73); a first engagement element (B1) capable of establishing a fixed gear mode in which rotation is transferred with the input member (30, 31) and the output member (73) connected to each other via the planetary gear (DP5) by making the third rotary element (R5) rotationally stationary when the first engagement element (B1) is engaged; and a second engagement element (C1) capable of establishing a continuously variable speed change mode in which rotation is transferred with the input member (30, 31) and the output member (73) connected to each other via the continuously variable speed change mechanism (40) when the second engagement element (C1) is engaged. With this configuration, the vehicle can travel in the fixed gear mode during travel at a low speed when the load torque is relatively large and travel in the continuously variable speed change mode during travel at a high speed when the load torque is relatively small, which can improve the fuel efficiency.

In addition, the automatic transmission (410) according to the embodiment further includes: a planetary gear unit (PU2) that has the planetary gear (DP5), a fourth rotary element (S6) drivably coupled to the third rotary element (R5) and capable of being made rotationally stationary by the second engagement element (B1), a fifth rotary element (CR6) drivably coupled to the second rotary element (CR5) and the output member (73), and a sixth rotary element (R6) capable of being made rotationally stationary, and that can change a speed of rotation of the output member (73), the fourth rotary element, the fifth rotary element, and the sixth rotary element being disposed on the second axis (AX2); and a third engagement element (B2) capable of establishing a reverse mode in which reverse rotation is transferred with the input member (30, 31) and the output member (73) connected to each other via the planetary gear unit (PU2) by making the sixth rotary element (R6) rotationally stationary when the third engagement element (B2) is engaged. In this configuration, the planetary gear (DP5) and the planetary gear (DP6) are disposed so as to overlap each other in the radial direction. Thus, the length of the automatic transmission (410) in the axial direction can be shortened to achieve a size reduction.

The automatic transmission relates to an automatic transmission mounted on a vehicle, for example, and specifically, is suitable, for example, for use as an automatic transmission that has a continuously variable speed change mechanism.

### DESCRIPTION OF THE REFERENCE NUMERALS

2 INTERNAL COMBUSTION ENGINE (DRIVE SOURCE)
10 AUTOMATIC TRANSMISSION
30, 31 INPUT SHAFT (INPUT MEMBER)
40 CONTINUOUSLY VARIABLE SPEED CHANGE MECHANISM
41 PRIMARY PULLEY
42 SECONDARY PULLEY
43 BELT
50 FORWARD/REVERSE SWITCHING MECHANISM
61 OUTPUT GEAR (DRIVE PINION GEAR)
73 DRIVE SHAFT (OUTPUT MEMBER)
90 TRANSFER MECHANISM
210 AUTOMATIC TRANSMISSION
310 AUTOMATIC TRANSMISSION
410 AUTOMATIC TRANSMISSION
AX1 FIRST AXIS
AX2 SECOND AXIS
AX3 THIRD AXIS
AX4 FOURTH AXIS
B1 FIRST BRAKE (SECOND ENGAGEMENT ELEMENT, THIRD ENGAGEMENT ELEMENT, FIRST ENGAGEMENT ELEMENT)
B2 SECOND BRAKE (THIRD ENGAGEMENT ELEMENT)
C1 FIRST CLUTCH (FIRST ENGAGEMENT ELEMENT, SECOND ENGAGEMENT ELEMENT)
C2 SECOND CLUTCH (SECOND ENGAGEMENT ELEMENT)
CR1 CARRIER (SECOND ROTARY ELEMENT)
CR2 CARRIER (SECOND ROTARY ELEMENT)
CR3 CARRIER (THIRD ROTARY ELEMENT)
CR4 CARRIER (SECOND ROTARY ELEMENT)
CR5 CARRIER (SECOND ROTARY ELEMENT)
CR6 CARRIER (FIFTH ROTARY ELEMENT)
DP1 PLANETARY GEAR
DP2 PLANETARY GEAR
DP3 PLANETARY GEAR
DP4 PLANETARY GEAR
DP5 PLANETARY GEAR
DP6 PLANETARY GEAR
L1 FIRST LINE
L2 SECOND LINE
PU1 PLANETARY GEAR UNIT
PU2 PLANETARY GEAR UNIT
R1 RING GEAR (THIRD ROTARY ELEMENT)
R2 RING GEAR (THIRD ROTARY ELEMENT)
R3 RING GEAR (FOURTH ROTARY ELEMENT)
R4 RING GEAR (THIRD ROTARY ELEMENT)
R5 RING GEAR (THIRD ROTARY ELEMENT)
R6 RING GEAR (SIXTH ROTARY ELEMENT)
S1 SUN GEAR (FIRST ROTARY ELEMENT)
S2 SUN GEAR (FIRST ROTARY ELEMENT)
S3 SUN GEAR (FIRST ROTARY ELEMENT)
S4 SUN GEAR (FIRST ROTARY ELEMENT)
S5 SUN GEAR (FIRST ROTARY ELEMENT)
S6 SUN GEAR (FOURTH ROTARY ELEMENT)

1-10. (canceled)

11. An automatic transmission comprising:
an input member disposed on a first axis and drivably coupled to a drive source;
a transfer mechanism that is provided between the first axis and a second axis that is parallel to the first axis and that transfers rotation around the first axis to the second axis;
a continuously variable speed change mechanism that is capable of continuously changing a speed ratio and has a primary pulley disposed on the second axis, a secondary pulley disposed on a third axis that is parallel to the second axis, and a belt wound around the two pulleys; and
an output member disposed on a fourth axis that is parallel to the third axis and meshed with a drive pinion gear on the third axis to output rotation at a changed speed, wherein
a center of the second axis and a center of the third axis are disposed on one side and the other side, respectively, of a first line that connects between a center of the first axis and a center of the fourth axis and that serves as a boundary as viewed in an axial direction.

12. The automatic transmission according to claim 11, wherein
the center of the second axis and the center of the third axis are disposed on a lower side and an upper side, respectively, of the first line that connects between the center of the first axis and the center of the fourth axis and that serves as the boundary as viewed in the axial direction.

13. The automatic transmission according to claim 12, wherein
a second line that connects between the center of the second axis and the center of the third axis intersects the first line between the center of the first axis and the center of the fourth axis as viewed in the axial direction.

14. The automatic transmission according to claim 11, wherein
the center of the third axis and the center of the second axis are disposed on a lower side and an upper side, respectively, of the first line that connects between the center of the first axis and the center of the fourth axis and that serves as the boundary as viewed in the axial direction.

15. The automatic transmission according to claim 14, wherein
a second line that connects between the center of the second axis and the center of the third axis intersects the first line between the center of the first axis and the center of the fourth axis as viewed in the axial direction.

16. The automatic transmission according to claim 11, wherein
a second line that connects between the center of the second axis and the center of the third axis intersects the first line between the center of the first axis and the center of the fourth axis as viewed in the axial direction.

17. The automatic transmission according to claim 11, further comprising:
a forward/reverse switching mechanism disposed on the second axis and capable of switching rotation input from the input member between forward rotation and reverse rotation and outputting the resultant rotation to the primary pulley.

18. The automatic transmission according to claim 17, wherein
the forward/reverse switching mechanism has: a planetary gear that is disposed on the second axis, that has a first rotary element drivably coupled to the input member, a second rotary element drivably coupled to the primary pulley, and a third rotary element capable of being made rotationally stationary, and that can change a speed of rotation of the output member; a first engagement element capable of establishing a forward mode in which forward rotation is transferred with the input member and the primary pulley connected to each other via the second rotary element when the first engagement element is engaged; and a second engagement element capable of establishing a reverse mode in which reverse rotation is transferred with the input member and the primary pulley connected to each other via the planetary gear by making the third rotary element rotationally stationary when the second engagement element is engaged.

19. The automatic transmission according to claim 11, further comprising:
a planetary gear that is disposed on the third axis, that has a first rotary element drivably coupled to the secondary pulley, a second rotary element to which rotation of the input member can be input, and a third rotary element drivably coupled to the output member, and that can change a speed of rotation of the output member;
a first engagement element capable of establishing a low-speed mode in which rotation is transferred with the input member and the output member connected to each other via the continuously variable speed change mechanism when the first engagement element is engaged; and
a second engagement element capable of establishing a high-speed mode in which rotation is transferred at a higher speed than when the first engagement element is engaged with the input member and the output member connected to each other via the planetary gear and the continuously variable speed change mechanism when the second engagement element is engaged.

20. The automatic transmission according to claim 11, further comprising:
a planetary gear unit that is disposed on the third axis, that has a first rotary element drivably coupled to the secondary pulley, a second rotary element to which rotation of the input member can be input, a third rotary element drivably coupled to the output member, and a fourth rotary element capable of being made rotationally stationary, and that can change a speed of rotation of the output member;
a first engagement element capable of establishing a low-speed mode in which rotation is transferred with the input member and the output member connected to each other via the planetary gear unit and the continuously variable speed change mechanism by making the fourth rotary element rotationally stationary when the first engagement element is engaged; and
a second engagement element capable of establishing a high-speed mode in which rotation is transferred at a higher speed than when the first engagement element is engaged with the input member and the output member connected to each other via the planetary gear unit and the continuously variable speed change mechanism when the second engagement element is engaged.

21. The automatic transmission according to claim 11, further comprising:
a first planetary gear that is disposed on the second axis, that has a first rotary element drivably coupled to the input member, a second rotary element drivably coupled to the output member, and a third rotary element capable of being made rotationally stationary, and that can change a speed of rotation of the output member;
a first engagement element capable of establishing a fixed gear mode in which rotation is transferred with the input member and the output member connected to each other via the planetary gear by making the third rotary element rotationally stationary when the first engagement element is engaged; and
a second engagement element capable of establishing a continuously variable speed change mode in which rotation is transferred with the input member and the output member connected to each other via the continuously variable speed change mechanism when the second engagement element is engaged.

22. The automatic transmission according to claim 21, further comprising:
a planetary gear unit that has the first planetary gear, and a second planetary gear that is disposed on the second axis and that has a fourth rotary element drivably coupled to the third rotary element and capable of being made rotationally stationary by the second engagement element, a fifth rotary element drivably coupled to the second rotary element and the output member, and a sixth rotary element capable of being made rotationally stationary, and that can change a speed of rotation of the output member; and
a third engagement element capable of establishing a reverse mode in which reverse rotation is transferred with the input member and the output member connected to each other via the planetary gear unit by making the sixth rotary element rotationally stationary when the third engagement element is engaged.
